(19) United States
(12) Patent Application Publication
(10) Pub. No.: US 2009/0303209 A1
(43) Pub. Date: Dec. 10, 2009

(54) Display Apparatus, Control Module and Method for the Display Apparatus

(75) Inventor: Sheng-Shan Teng, Taoyuan Hsien (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: DELTA ELECTRONICS, INC., Taoyuan Hsien (TW)

(21) Appl. No.: 12/198,327

(22) Filed: Aug. 26, 2008

(30) Foreign Application Priority Data
Jun. 5, 2008 (TW) 097121000

(51) Int. Cl. G09G 3/36; G09G 5/00

(52) U.S. Cl. 345/204; 345/88

(57) ABSTRACT

A display apparatus, a control module and a method for the display apparatus are provided. The control module comprises a color sensing unit, a light sensing unit, and a processor. The color sensing unit is configured to sense and output color information of the display apparatus. The light sensing unit is configured to sense an environmental brightness and output brightness information. The processor receives the color information and the brightness information to generate a color temperature adjustment signal and a brightness adjustment signal respectively. Thereby, the display apparatus may automatically adjust the color temperature and brightness in response to the color temperature adjustment signal and the brightness adjustment signal.

This application claims the benefit of priority based on Taiwan Patent Application No. 097121000, filed on Jun. 5, 2008, the contents of which is incorporated herein by reference in its entirety.

### CROSS-REFERENCES TO RELATED APPLICATIONS

Not applicable.

### BACKGROUND OF THE INVENTION

1. Field of the Invention

The present invention relates to a display apparatus, and a control module and a control method for the display apparatus. In particular, the present invention relates to a control module with a color sensing unit and a light sensing unit integrated therein; a display apparatus that employs this control module by adjusting both the color temperature and the brightness thereof; and a control method for adjusting both the color temperature and the brightness.

2. Descriptions of the Related Art

Over recent years, flat panel displays are developing at a rapid pace and have gradually replaced conventional cathode ray tube (CRT) displays. Flat panel displays currently available primarily fall into the following categories: organic light-emitting diode displays (OLEDs), plasma display panels (PDPs), liquid crystal displays (LCDs) and field emission displays (FEDs). Among these displays, LCDs have become the mainstream product in the display market due to advantages, such as a low power consumption, light weight and high resolution.

Conventional LCD televisions or LCDs tend to experience a shift or variation in both the color temperature and brightness after a period of use, which may further cause the poor quality of images displayed. To modulate the shifted color temperature or the decayed brightness of an LCD television or an LCD back to the originally preset values, the typical user usually has to perform this manually by observing the screen with naked eyes.

However, in case an LCD television or a digital electronic display panel composed of LCDs is suspended at a high position or positioned on a display cabinet, it will be very difficult for the typical user to manually adjust or correct the color temperature or brightness of the screen thereof.

For this reason, when overcoming the problem of color temperature shifting, display manufacturers usually provide an R.G.B. sensor to sense the color temperature of a screen and accordingly modulate the shifted color temperature back to the original value preset before shipping the screen. Typical R.G.B. sensors need to equip with a light tube to assist the sensor in sensing the color temperature from the screen. However, because light tubes are made of different materials, it is impossible for the R.G.B. sensors to accurately sense the color temperature of the screen. Furthermore, the light tube used with a R.G.B. sensor is typically disposed at the corners outside the screen, resulting in an inaesthetic appearance of the screen due to the bulky volume of the light tube.

To facilitate the brightness adjustment of the screen, display manufacturers usually provide a light sensor capable of sensing brightness to sense brightness of the environment or the screen itself to adjust the brightness of the screen accordingly. Unfortunately, for general display screens without light sensors, the user has to adjust the brightness parameter of an LCD television or an LCD manually by means of an On-Screen Display (OSD) function thereof, and then store the adjusted brightness parameter in the LCD television or the LCD. However, for digital electronic display panels suspended at high positions or positioned on display cabinets, it will be difficult for the user to manually adjust the brightness of screen.

In view of this, it is important to provide a display apparatus that can automatically adjust the color temperature and brightness of a screen without the use of any light tube thereof, and has both the R.G.B. sensor and a light sensor integrated into a single module.

### SUMMARY OF THE INVENTION

One objective of this invention is to provide a control module for a display apparatus, which comprises a color sensing unit and a processor. The color sensing unit is configured to sense and output color information of the display apparatus. The processor is configured to receive the color information and to compare the color information with a default value to generate a color temperature adjustment signal so that a color temperature of the display apparatus is capable of being adjusted in response to the color temperature adjustment signal. As a result, the control module of this invention can adjust the color temperature of the display apparatus automatically without using any light tube.

Another objective of this invention is to provide a control method for a display apparatus comprising the following steps: sensing and outputting color information of the display apparatus; receiving the color information; comparing the color information with a default value to generate a color temperature adjustment signal; and adjusting a color temperature of the display apparatus in response to the color temperature adjustment signal. Consequently, when shifting the color temperature in the display apparatus, the shifted color temperature can be automatically adjusted back to the original preset value by this control method.

Yet a further objective of this invention is to provide a display apparatus, which comprises a display panel and a control module. The control module has a color sensing unit, a light sensing unit and a processor. The color sensing unit is configured to sense and output color information of the display apparatus. The light sensing unit is configured to sense an environmental brightness and output brightness information. The color sensing unit and the light sensing unit are disposed on the same printed circuit board (PCB). The processor is configured to receive the color information and compare the color information with the brightness information to generate a color temperature adjustment signal and a brightness adjustment signal. As a result, the display apparatus is capable of automatically adjusting a color temperature and brightness thereof in response to the color temperature adjustment signal and the brightness adjustment signal.

By integrating a color sensing unit and a light sensing unit into a single PCB and disposing the PCB into a control module, this invention is capable of modulating the color temperature and brightness of a display apparatus automatically. Meanwhile, the volume of the color sensing unit may be miniaturized to further obviate the need of manual adjustment on the color temperature and brightness in the display apparatus of the prior art, thus producing diversified display products.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating the preferred embodiment of the present invention;

FIG. 2 is a flow chart illustrating a process for modulating the color temperature;

FIG. 3 is a flow chart illustrating a process for modulating brightness; and

FIG. 4 is a schematic view illustrating display apparatuses with a control module of the present invention applied to a digital video wall.

### DESCRIPTION OF THE PREFERRED EMBODIMENT

In the following description, this invention will be explained with reference to embodiments thereof. However, these embodiments are not intended to limit this invention to any specific environment, applications or particular implementations described in these embodiments. Therefore, description of these embodiments is only provided for purpose of illustration but not to limit this invention. It should be appreciated that in the following embodiments and the attached drawings, elements not related directly to this invention are omitted from depiction.

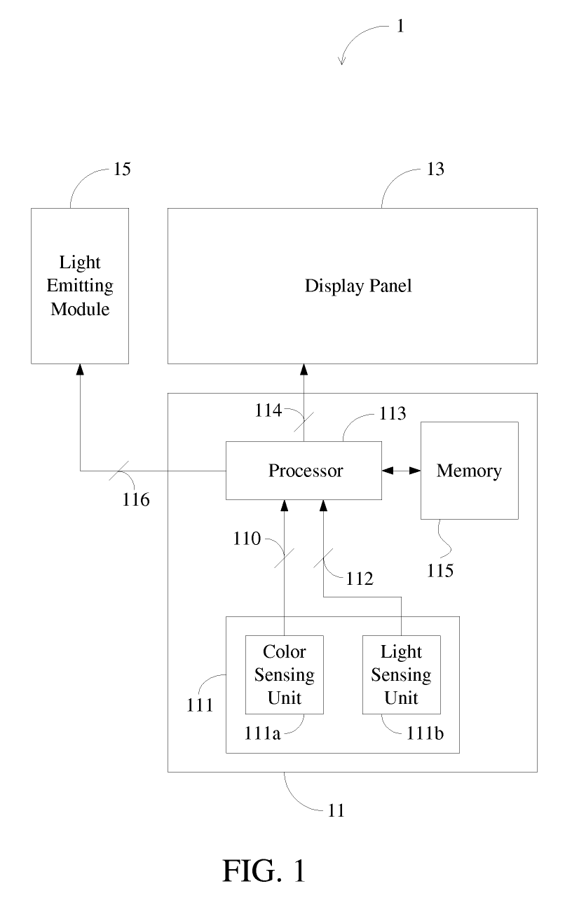

FIG. 1 is a schematic view of a display apparatus 1 according to the preferred embodiment of this invention. The display apparatus 1 comprises a control module 11, a display panel 13 and a light emitting module 15. The light emitting module 15 is primarily configured to provide the display panel 13 with light necessary for displaying images. The control module 11 has a color sensing unit 111a, a light sensing unit 111b, a processor 113 and a memory 115. The color sensing unit 111a and the light sensing unit 111b have been integrated into a printed circuit board (PCB) early at an initial manufacturing stage of the display apparatus to be easily disposed at any position in the display apparatus 1. In this way, the control module 11 is capable of sensing both the color temperature and the brightness of the display panel 13. In response to the sensed results, the color temperature of the display panel 13 and the brightness of the light emitting module 15 can be correctly adjusted.

The color sensing unit 111a of the control module 11 is an R.G.B. sensor for sensing the color temperature of the three primary colors (i.e., red, green and blue) respectively, and generating color information thereafter. In this embodiment, the color sensing unit 111a may be a CM3312 sensor from CAPELLA MICROSYSTEM, INC., which is configured to sense the color temperature of the three primary colors on the display panel 13. However, the CM3312 sensor is not intended to limit the scope of this invention, and those of ordinary skill in the art will know that the CM 3312 sensor may be substituted by any elements with an equivalent or similar function. Upon sensing the color temperature of the three primary colors on the display panel 13, the color sensing unit 111a outputs color information 110 which contains data corresponding to the three primary colors, i.e., red data, green data and blue data (for convenience of description, the red data, the green data and the blue data will be denoted by R, G, B data respectively hereinafter).

The light sensing unit 111b of the control module 11 is a light sensor configured to sense an environmental brightness (not shown). In this embodiment, the light sensing unit 111b may be a CM3211 sensor from CAPELLA MICROSYSTEM, INC. However, the CM3211 sensor is not intended to limit the scope of this invention, and those of ordinary skill in the art will know that the CM3211 sensor may be substituted with any elements that have an equivalent or similar function. Upon sensing the environmental brightness, the light sensing unit 111b outputs brightness information 112.

The default color temperature values of the three primary colors have been stored in the memory 115 of the control module 11 before shipping the display apparatus 1. It should also be noted that the memory 115 also stores a look-up table recording a relationship between the environmental brightness and the light emitting degree of the light emitting module 15. The adjustment of the light emitting degree of the light emitting module 15 of the display apparatus will be detailed hereinafter.

The calculation of the default color temperature values of the three primary colors on the display panel 13 in this embodiment will now be described. The data of the three colors on the display panel 13 are represented in a digital form, so if each of the three primary colors is represented by 8 bits, 256 color levels may be defined for each of the three primary colors. In more detail, each of the red, the green and the blue data has color levels 0 to 255, and by combining the different color levels of each of the primary colors, various colors may be obtained. For example, a color level combination of (0, 0, 0) corresponding to the (red data, green data, blue data) represents a full black image that is displayed by the display panel 13, while a color level combination of (255, 255, 255) corresponding to the (red data, green data, blue data) represents a full white image that is displayed by the display panel 13. Similarly, a color level combination of (255, 0, 0) corresponding to the (red data, green data, blue data) represents a full red image that is displayed by the display panel 13.

For example, if the display apparatus 1 has three display modes, namely, a Low display mode, a Medium display mode and a High display mode, the memory 115 needs to store three groups of default color temperature values corresponding to the three display modes. When the display apparatus 1 is set to the Low display mode, the display panel 13 exhibits color temperature of 6500K in an indoor environment, where K is the absolute temperature scale. In this case, the processor 113 calculates the default values corresponding to the color temperature 6500K based on a full white image (i.e., a color level combination of set to (255, 255, 255)) and the following formula (1):

$$[ \begin{matrix}0.4125 & 0.3576 & 0.1804 \\ 0.2127 & 0.7152 & 0.0722 \\ 0.0193 & 0.1192 & 0.9503\end{matrix} ] \qquad ( 1 )$$

Through the calculation according to the formula (2), X, Y and Z values that exhibit a color temperature of 6500K in the indoor environment are obtained.

$${[ \begin{matrix}X \\ Y \\ Z\end{matrix} ]}_{D 65} = [ \begin{matrix}0.4125 & 0.3576 & 0.1804 \\ 0.2127 & 0.7152 & 0.0722 \\ 0.0193 & 0.1192 & 0.9503\end{matrix} ] [ \begin{matrix}255 \\ 255 \\ 255\end{matrix} ] = {[ \begin{matrix}242.380 \\ 255.025 \\ 277.644\end{matrix} ]}_{D 65} \qquad ( 2 )$$

Next, the processor 113 converts the X, Y and Z values that exhibit color temperature of 6500K in the indoor environment into x and y coordinates and a brightness value Y in the CIE 1931 chart according to the following formulas (3) to (5):

$$\begin{matrix}x = \frac{X}{X + Y + Z} = \frac{242.380}{242.380 + 255.025 + 277.644} = 0.313 & ( 3 ) \\ y = \frac{Y}{X + Y + Z} = \frac{255.025}{242.380 + 255.025 + 277.644} = 0.329 & ( 4 ) \\ Y = 255.025 \times 2 = 510 ( nits ) & ( 5 )\end{matrix}$$

where the subscript D65 represents that the X, Y, Z values correspond to 6500K, and nit is the unit of brightness. Accordingly, when the display panel 13 exhibits a color temperature of 6500K in the indoor environment, the memory 115 stores the default values of x=0.313, y=0.329 and Y=510.

When the display apparatus 1 is set to the Medium display mode, the display panel 13 exhibits a color temperature of 9300K in the indoor environment. In this case, the processor 113 calculates the default values corresponding to the color temperature 9300K based on the X, Y, Z values of the color temperature 6500K (i.e., (242.380, 255.025, 277.644)) and the following formula (6):

$$[ \begin{matrix}0.956 & - 0.021 & 0.059 \\ - 0.002 & 1.001 & 0.002 \\ 0.011 & - 0.019 & 1.305\end{matrix} ] \qquad ( 6 )$$

Through the calculation according to the formula (7), X, Y and Z values that exhibit a color temperature of 9300K in the indoor environment are obtained.

$${[ \begin{matrix}X \\ Y \\ Z\end{matrix} ]}_{D 93} = {[ \begin{matrix}0.956 & - 0.021 & 0.059 \\ - 0.002 & 1.001 & 0.002 \\ 0.011 & - 0.019 & 1.305\end{matrix} ] [ \begin{matrix}242.380 \\ 255.025 \\ 277.644\end{matrix} ]}_{D 65} = {[ \begin{matrix}242.74 \\ 255.35 \\ 360.15\end{matrix} ]}_{D 93} \qquad ( 7 )$$

Next, the processor 113 converts the X, Y and Z values that exhibit color temperature of 9300K in the indoor environment into x and y coordinates and a brightness value Y in the CIE 1931 chart according to the following formulas (8) to (10):

$$\begin{matrix}x = \frac{X}{X + Y + Z} = \frac{242.74}{242.74 + 255.35 + 360.15} = 0.283 & ( 8 ) \\ y = \frac{Y}{X + Y + Z} = \frac{255.35}{242.74 + 255.35 + 360.15} = 0.298 & ( 9 ) \\ Y = 255.35 \times 2 = 511 ( nits ) & ( 10 )\end{matrix}$$

Accordingly, when the display panel 13 exhibits color temperature of 9300K in the indoor environment, the memory 115 stores the default values of x=0.283, y=0.298 and Y=511.

Similarly, when the display apparatus 1 is set to the High display mode, the display panel 13 exhibits a color temperature of 12000K in the indoor environment. In this case, the processor 113 also calculates the default values corresponding to the color temperature 12000K based on the X, Y, Z values of the color temperature 6500K (i.e., (242.380, 255.025, 277.644)) and the following formula (11):

$$[ \begin{matrix}0.9472 & 0.0220 & 0.0927 \\ 0.0233 & 0.9904 & 0.0299 \\ 0.0195 & 0.0332 & 1.4998\end{matrix} ] \qquad ( 11 )$$

Through the calculation according to formula (12), X, Y and Z values that exhibit color temperature of 12000K in the indoor environment are obtained.

$${[ \begin{matrix}X \\ Y \\ Z\end{matrix} ]}_{D 120} = {[ \begin{matrix}0.9472 & 0.0220 & 0.0927 \\ 0.0233 & 0.9904 & 0.0299 \\ 0.0195 & 0.0332 & 1.4998\end{matrix} ] [ \begin{matrix}242.380 \\ 255.025 \\ 277.644\end{matrix} ]}_{D 65} = {[ \begin{matrix}260.93 \\ 266.52 \\ 429.60\end{matrix} ]}_{D 120} \qquad ( 12 )$$

Next, the processor 113 converts the X, Y and Z values that exhibit color temperature of 12000K in the indoor environment into x and y coordinates and a brightness value Y in the CIE 1931 chart according to the following formulas (13) to (15):

$$\begin{matrix}x = \frac{X}{X + Y + Z} = \frac{260.93}{260.93 + 266.52 + 429.60} = 0.2726 & ( 13 ) \\ y = \frac{Y}{X + Y + Z} = \frac{266.52}{260.93 + 266.52 + 429.60} = 0.2785 & ( 14 ) \\ Y = 266.52 \times 2 = 533 ( nits ) & ( 15 )\end{matrix}$$

Accordingly, when the display panel 13 exhibits a color temperature of 12000K in the indoor environment, the memory 115 stores the default values of x=0.2726, y=0.2785 and Y=533.

It should be noted that the processor 113 is not limited to store only the default x, y, Y values corresponding to the 6500K, 9300K and 12000K respectively. Rather, those of ordinary skill in the art may calculate default values corresponding to other color temperatures based on the above description and thus, this will not be further described herein.

Once the color sensing unit 111a outputs the color information 110 or the light sensing unit 111b outputs the brightness information 112, the processor 113 receives the color information 110 from the color sensing unit 111a or the brightness information 112 from the light sensing unit 111b via an I²C bus. Meanwhile, the processor 113 reads the default color temperature values and the look-up table stored in the memory 115.

For example, in the Medium display mode (i.e. x=0.283, y=0.298 and Y=511), if the color information 110 received by the processor 113 has values of x=0.280, y=0.290 and Y=480, it means that color temperature shifting has occurred in the display panel 13 of the display apparatus 1. In response to the color temperature shifting, the processor 113 generates a color temperature adjustment signal 114 for transmission to the display panel 13 to adjust the associated parameters, i.e., to adjust the color levels of the red data, the green data and the blue data in the display panel 13, so that the color temperature of the display panel 13 is adjusted back to the original value preset before shipping the display apparatus 1.

More specifically, in this embodiment, after the processor 113 receives the color information 110 and during the process of adjusting the x, y and Y values corresponding to the color information 110 gradually to the preset values, the x and y values corresponding to the color information 110 are incremented or decremented gradually in steps of 0.001 to approach the default x and y values, while the Y value corresponding to the color information 110 is incremented or decremented gradually in steps of 1 to approach the default Y value. For example, in the Medium display mode, the shifted x and y values (i.e., x=0.280, y=0.290) corresponding to the color information 110 will be incremented gradually in steps of 0.001 to the original default values of x=0.283, y=0.298 when the processor 113 receives the color information 110, while the shifted Y value corresponding to the color information 110 is incremented gradually in steps of 1 to the original default value of Y=511. It should be noted that in this invention, steps in which the aforesaid values are incremented/decremented are not merely limited to 0.001 and 1, and manufacturers may also use other steps (e.g., 0.002 and 2) to adjust the x, y and Y values. These adjustments will be appreciated by those of ordinary skill in the art and thus, will not be further described herein.

In respect to the brightness adjustment of the display panel 13, the processor 113 compares the brightness information 112 with the look-up table stored in the memory 115 to determine whether the environmental brightness has changed upon receiving the brightness information 112 from the light sensing unit 111b. If the environmental brightness has not changed yet, the processor 113 continues to sense the environmental brightness by using the light sensing unit 111b. The aforesaid look-up table is shown in Table 1.

TABLE 1

| Environmental Brightness (Lux) | Pulse Width Modulation (%) |
|---|---|
| 1000 and above | 85 |
| 750~999 | 75 |
| 500~749 | 65 |
| 350~499 | 55 |
| 200~349 | 45 |
| 100~199 | 35 |
| 10~99 | 25 |

More specifically, if all fluorescent lamps in an office are turned on, the illumination intensity in the office may exceed 1000 lux, in which case the processor 113 will transmit a brightness adjustment signal 116 to the light emitting module 15 to adjust the light emitting degree thereof through pulse width modulation (PWM). In more detail, the brightness adjustment signal 116 adjusts the pulse width of the light emitting module 15 to 85%, or even to 100% to enhance the light emitting degree of the light emitting module 15 and consequently the brightness of the display panel 13. Conversely, if some of the fluorescent lights are turned off, the illumination intensity in the office may drop down to 400 lux, in which case the brightness information 112 from the light sensing unit 111b will experience a change. Accordingly, the processor 113 transmits the light emitting module 15 to another brightness adjustment signal 116 which adjusts the pulse width of the light emitting module 15 to 55% to decrease the light emitting degree of the light emitting module 15 and consequently the brightness of the display panel 13.

PWM is well-known to those of ordinary skill in the art, and thus will not be further described herein. The light emitting module 15 is composed of one of a light emitting diode (LED) and a cold cathode fluorescent lamp (CCFL). However, the LED and CCFL are not intended to limit the scope of this invention.

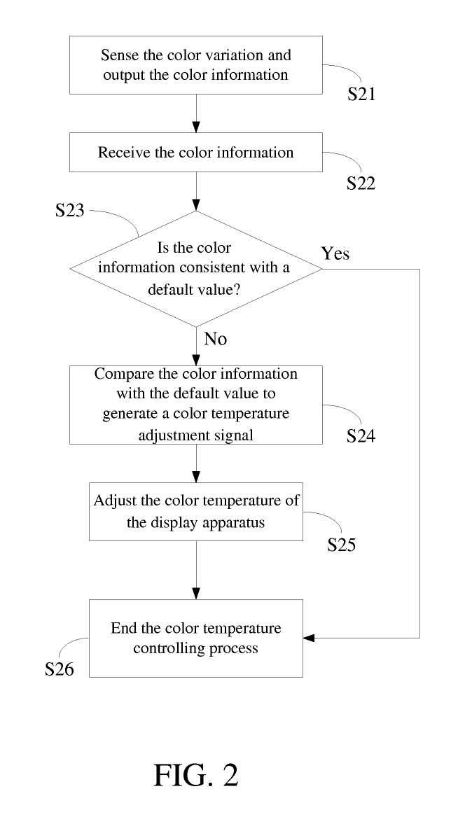

A flow diagram of the aforesaid process of adjusting the color temperature of the display panel 13 is depicted in FIG. 2. Initially in step S21, the color variation that is sensed by a color sensing unit to output color information to a processor via an I²C bus. Next, in step S22, the color information is received by the processor. Then, in step S23, the RGB data contained in the color information is retrieved and processed by the processor to determine whether the color information is consistent with a default value. If so, step S26 is executed to end the color temperature controlling process. Otherwise, step S24 is executed to compare the color information with the default value to generate a color temperature adjustment signal. In more detail, in steps S23 and S24, the processor determines whether it is necessary to generate a color temperature adjustment signal to adjust the shifted color temperature of the display apparatus. Then, in step S25, the color temperature adjustment signal is transmitted to the display panel of the display apparatus to adjust the color temperature thereof. Once the adjustment on the color temperature is completed, the process proceeds to step S26 to end the color temperature controlling process.

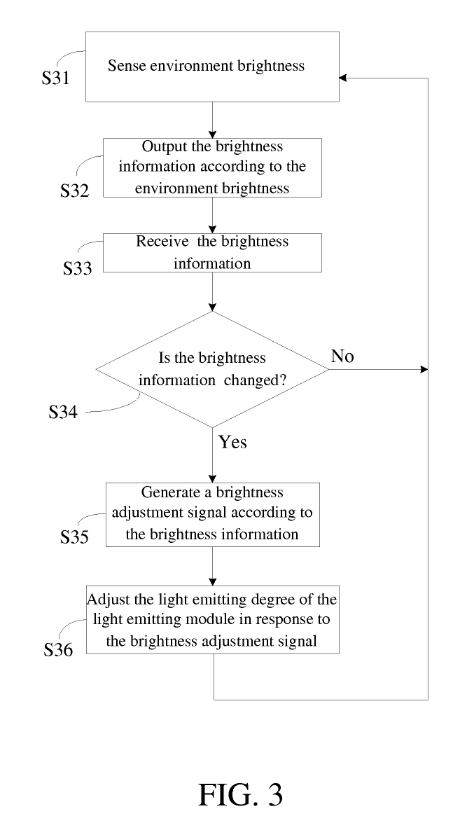

The flow diagram of the aforesaid process of adjusting the light emitting degree of the light emitting module 15 is depicted in FIG. 3. Initially in step S31, environment brightness is sensed by a light sensing unit. Next in step S32, the brightness information is outputted by the light sensing unit to the processor according to the environment brightness. Then, in step S33, the brightness information is received by the processor. In step S34, the processor compares the received brightness information with a look-up table stored in the memory to determine whether the brightness information has changed. If the brightness information has not changed yet, the process returns back to step S31 to continue the sensing of the environmental brightness. Otherwise, if the brightness information has changed, step S35 is executed to generate a brightness adjustment signal according to the brightness information. Finally, in step S36, the light emitting degree of the light emitting module is adjusted in response to the brightness adjustment signal to adjust the brightness of the display apparatus. Once the adjustment on brightness of the display apparatus is completed, the process returns to step S31 to continue the sensing of the environmental brightness.

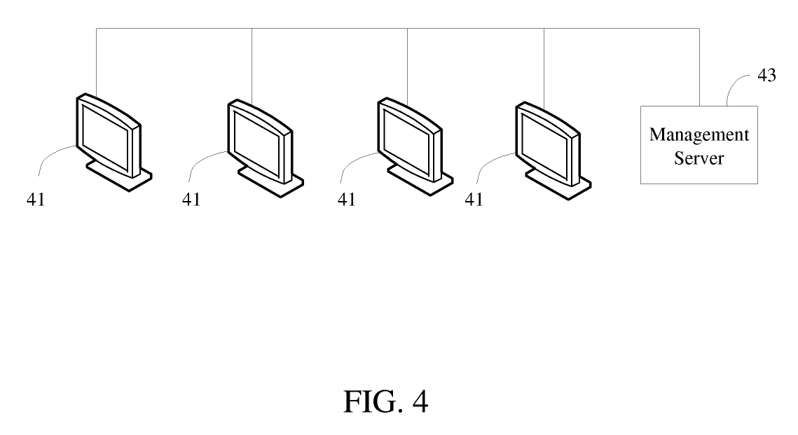

Another application of this invention is depicted in FIG. 4, which schematically illustrates the application of the control module 11 to a digital video wall. Four digital televisions 41 are depicted, each of which has a control module 11 disposed at the bottom right corner of a screen thereof. Through an RS232 cable, the digital televisions 41 are connected in series with each other and then connected to a management server 43, so that the management server 43 reads the color information 110 and the brightness information 112 transmitted by the control module 11 of each of the digital televisions 41. After operation for an extended period of time, the digital televisions 41 will experience both color temperature shifting and brightness attenuation relative to the default values. In this case, the management server 43 compares the received color information 110 with the default value to adjust the color temperature. Meanwhile, the management server 43 adjusts the brightness according to the comparison of the received brightness information 112 with the look-up table. Adjustment of the color temperature and the brightness is just as described above and will be appreciated by those of ordinary skill in the art, so this will not be further described herein. It should be noted that in this invention, the number of digital televisions 41 of the video wall is not merely limited to four, and another number of digital televisions 41 may be used instead to form a video wall.

In summary, by integrating the color sensing unit and light sensing unit into a single PCB and disposing the PCB into a control module, this invention is capable of adjusting the color temperature and brightness of a display apparatus automatically. Meanwhile, the volume of the color sensing unit may be miniaturized to further obviate the need of manual adjustment on the color temperature and brightness as occurred in the prior art display apparatus.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A control module for a display apparatus, comprising:
a color sensing unit being configured to sense and output color information of the display apparatus; and
a processor being configured to receive the color information and to compare the color information with a default value to generate a color temperature adjustment signal, in order that a color temperature of the display apparatus is capable of being adjusted in response to the color temperature adjustment signal.

2. The control module as claimed in claim 1, further comprising a memory being configured to store the default value.

3. The control module as claimed in claim 1, further comprising a light sensing unit being configured to sense an environmental brightness and output brightness information, wherein the processor receives the brightness information and generates a brightness adjustment signal according to the brightness information, in order that brightness of the display apparatus is capable of being adjusted in response to the brightness adjustment signal.

4. The control module as claimed in claim 3, further comprising a memory being configured to store a look-up table, wherein the look-up table records a relationship between the environmental brightness and the brightness adjustment signal.

5. The control module as claimed in claim 3, wherein the color sensing unit and the light sensing unit are disposed on a printed circuit board (PCB).

6. The control module as claimed in claim 3, wherein the brightness of the display apparatus is adjusted by pulse width modulation (PWM) in response to the brightness adjustment signal.

7. The control module as claimed in claim 3, wherein the color information and the brightness information are transmitted via an I²C bus.

8. The control module as claimed in claim 1, wherein the color information comprises red data, green data, and blue data.

9. A control method for a display apparatus, comprising the steps of:
sensing and outputting color information;
receiving the color information;
comparing the color information with a default value to generate a color temperature adjustment signal; and
adjusting a color temperature of the display apparatus in response to the color temperature adjustment signal.

10. The control method as claimed in claim 9, further comprising the steps of:
sensing an environmental brightness;
outputting brightness information according to the environmental brightness;
generating a brightness adjustment signal according to the brightness information; and
adjusting brightness of the display apparatus in response to the brightness adjustment signal.

11. The control method as claimed in claim 10, wherein the brightness of the display apparatus is adjusted by pulse width modulation.

12. A display apparatus, comprising:
a display panel; and
a control module, having:
a color sensing unit being configured to sense and output color information of the display apparatus; and
a processor being configured to receive the color information and to compare the color information with a default value to generate a color temperature adjustment signal, in order that a color temperature of the display panel is capable of being adjusted in response to the color temperature adjustment signal.

13. The display apparatus as claimed in claim 12, wherein the control module further has a memory being configured to store the default value.

14. The display apparatus as claimed in claim 12, further comprising a light emitting module, wherein the control module further comprises a light sensing unit being configured to sense an environmental brightness and output brightness information, the processor receives the brightness information and generates a brightness adjustment signal according to the brightness information, in order that light emitting degree of the light emitting module is capable of being adjusted in response to the brightness adjustment signal.

15. The display apparatus as claimed in claim 14, wherein the control module further has a memory being configured to store a look-up table, the look-up table records a relationship between the environmental brightness and the light emitting degree of the light emitting module.

16. The display apparatus as claimed in claim 14, wherein the color sensing unit and the light sensing unit are disposed on a printed circuit board.

17. The display apparatus as claimed in claim 14, wherein the light emitting degree of the light emitting module is adjusted by pulse width modulation in response to the brightness adjustment signal.

18. The display apparatus as claimed in claim 14, wherein the color information and the brightness information are transmitted via an I²C bus.

19. The display apparatus as claimed in claim 12, wherein the color information comprises red data, green data, and blue data.
